(19) United States
(12) Patent Application Publication
(10) Pub. No.: US 2019/0309175 A1
(43) Pub. Date: Oct. 10, 2019

(54) COATING METHOD AND PRODUCT THEREOF

(71) Applicants: SCG CHEMICALS CO., LTD., Bangkok (TH); SCG PACKAGING PUBLIC COMPANY LIMITED, Bangkok (TH)

(72) Inventors: Dermot O'Hare, Oxford (GB); Jean-Charles Buffet, Oxford (GB); Kanittika Ruengkajorn, Oxford (GB)

(21) Appl. No.: 16/349,784

(22) PCT Filed: Nov. 15, 2017
(86) PCT No.: PCT/GB2017/053444

§ 371 Date: May 14, 2019

(30) Foreign Application Priority Data
Nov. 15, 2016 (GB) 1619319.5

(51) Int. Cl. C09D 5/08; B32B 7/12; C09D 129/04; C08J 7/04; C08J 5/18; C09J 7/29; C09J 11/04

(52) U.S. Cl. CPC C09D 5/084; B32B 7/12; C09D 129/04; C08J 7/047; C08J 5/18; C09J 7/29; C08K 2003/267; B32B 2255/26; B32B 2307/7244; B32B 2439/70; C08J 2367/02; C08J 2429/04; C09J 11/04

(57) ABSTRACT

A process for the preparation of a film is described, in which a substrate is coated with a coating mixture containing a water-soluble polymer and a layered double hydroxide. The process of the invention is markedly simpler that conventional techniques for affording films having reduced permeability to degradative gases. The films obtainable by the process are particularly useful in packaging applications, notably in the food industry.

### INTRODUCTION

The present invention relates to a process for the preparation of a film, as well as to films obtainable by the process and their uses in packaging applications. More specifically, the present invention relates to a process for the preparation of a film comprising an LDH-containing coating.

### BACKGROUND OF THE INVENTION

Polymer films have been widely applied as packaging materials (e.g. in the food industry) due to their light weight, low cost and good processability (T. Pan, S. Xu, Y. Dou, X. Liu, Z. Li, J. Han, H. Yan and M. Wei, J. Mater. Chem. A, 2015, 3, 12350-12356). However, the effectiveness of polymer packaging materials in preventing product degradation depends on their impermeability to degradative gases such as oxygen (Y. Dou, S. Xu, X. Liu, J. Han, H. Yan, M. Wei, D. G. Evans and X. Duan, Adv. Fund. Mater., 2014, 24, 514-521) and water vapour.

In an endeavour to reduce the gas permeability of polymeric films used in packaging applications, inorganic materials have been incorporated directly into the polymeric films themselves (e.g. as fillers), or have been applied to the surface of such polymeric films (e.g. as a coating). Clays (such as montmorillonite) have been considered promising candidate materials for reducing the gas permeability of polymeric films. However, these materials suffer from the fact that they are naturally-occurring, and as such may be heavily contaminated with potentially harmful substances (e.g. heavy metals), thereby hampering their use in food packaging.

Aside from clays, layered-double hydroxides (LDHs) have been recognised as potentially useful materials for reducing the gas permeability of polymeric films. However, to date, research in the area of LDH coatings on polymeric films has focussed on the preparation of a complex “brick-mortar” structure obtained via layer-by-layer (LbL) assembly of LDH nanoplatelets and polymer on the film, in which a highly-ordered stack of alternating layers of LDH (brick) and polymer (mortar) is prepared by a series of alternating spin or dip coating steps using i) an LDH dispersion, and ii) a polymer solution. These assemblies have been rendered even more complex by infilling voids with CO₂ (to give a “brick-mortar-sand” structure) in an endeavour to further reduce the oxygen transmission rate (OTR) of the polymeric film. However, the elaborate and complex nature of such LbL techniques restricts their implementation on an industrial scale.

In spite of the advances made by the prior art, there remains a need for improved means for reducing the gas permeability of polymeric films. In particular, there remains a need for an overall simpler coating technique allowing for the preparation of coated polymeric films having acceptable OTR and water-vapour transmission rate (WVTR) properties.

The present invention was devised with the foregoing in mind.

### SUMMARY OF THE INVENTION

According to a first aspect of the present invention there is provided a process for the preparation of a film, the process comprising the steps of:
a) providing a first substrate;
b) providing an aqueous mixture comprising a water-soluble polymer and a water-dispersible layered-double hydroxide;
c) coating the first substrate with a layer of the aqueous mixture; and
d) drying the coated first substrate.

According to a further aspect of the present invention there is provided a film obtainable, obtained or directly obtained by a process as defined herein.

According to a further aspect of the present invention there is provided a film comprising:
a) a substrate; and
b) a coating layer provided on a least one surface of the substrate,
   wherein the coating layer comprises 5-70 wt % of layered double hydroxide dispersed throughout a water-soluble polymeric matrix.

According to a further aspect of the present invention there is provided a use of a film as defined herein in packaging.

According to a further aspect of the present invention there is provided a container comprising a film as defined herein.

### DETAlLED DESCRIPTION OF THE INVENTION

Preparation of Films

As discussed hereinbefore, the present invention provides a process for the preparation of a film, the process comprising the steps of:
a) providing a first substrate;
b) providing an aqueous mixture comprising a water-soluble polymer and a water-dispersible layered-double hydroxide;
c) coating the first substrate with a layer of the aqueous mixture; and
d) drying the coated first substrate.

The process of the invention provides a number of advantages over conventional techniques for reducing the gas permeability characteristics of polymeric films. When compared with techniques employing the use of an inorganic filler in the film itself, the present invention is advantageous in that it allows various different films to be coated with the same coating mixture. Hence, it not necessary for each polymeric film (e.g. PET, PU, PE) to be purpose-made with the inclusion of an inorganic filler.

The use of LDH in the process of the invention also presents numerous advantages over prior art techniques employing clays. In contrast to clays (e.g. montmorillonite), LDHs are entirely synthetic materials, the composition, structure and morphology of which is wholly governed by the manner in which they are prepared. As a consequence, the replacement of clays with LDHs in polymeric films for packaging applications considerably reduces—if not eliminates—the risk posed by potentially harmful contaminants (such as heavy metals), which present clear advantages for the food industry.

The process of the invention also presents a number of advantages over conventional LbL assembly techniques. As discussed hereinbefore, LbL techniques have been used to prepare complex “brick-mortar” structures, containing a highly-ordered stack of alternating layers of LDH (brick) and polymer (mortar) which is grown directly on a film by a series of alternating spin or dip coating steps using i) an LDH dispersion, and ii) a polymer solution, or is assembled separate from the film prior to being transferred onto it. In contrast to this approach, the present invention provides a considerably simpler technique for achieving coated polymeric films having acceptable OTR and WVTR properties. In particular, in the present process, both the LDH and the polymer are simultaneously applied to the film in a single step, whereas LbL processes require successive alternating separate steps for applying the LDH and polymer. This necessarily facilitates up-scaling of the present process, the coating mixture of which can be applied to the film from a single vessel in a production line in a single application step. Moreover, the present process provides a greater degree of flexibility in the manner in which the coating mixture may be applied to the film on an industrial scale. As a non-limiting example, the present process may be implemented using a roller-and-bath apparatus, in which the coating mixture is licked onto a roller being in contact with a bath, and is then transferred onto a film also being in contact with the roller, thereby allowing vast quantities of film to be continuously coated in a short period of time. Such cost-effective techniques are entirely incompatible with LbL techniques, the complex structures of which can only be achieved by sequential dip or spray coating techniques.

In an embodiment, the first substrate is selected from polyethylene terephthalate (PET), polyethylene (PE), biaxially oriented polypropylene film (BOPP), polypropylene (PP), polyvinyl dichloride (PVDC), polyamide, nylon, and polylactic acid (PLA). Suitably, the first substrate is PET.

In an embodiment, the water-soluble polymer is selected from one or more of poly(vinyl alcohol) (PVOH), copolymers comprising vinyl alcohol (e.g. polyethylene vinyl alcohol (EVOH)) and polyacrylic acid (PAA).

The water-soluble polymer may have a molecular weight of 400 to 150,000 Da.

Suitably, the water-soluble polymer is poly(vinyl alcohol) or poly(lactic acid). More suitably, the water-soluble polymer is poly(vinyl alcohol), preferably having a molecular weight of 20,000 to 150,000 Da. Alternatively, the poly(vinyl alcohol) may have a molecular weight of 70,000 to 80,000 Da.

In an embodiment, the aqueous coating mixture of step b) is prepared by:
b1) dissolving the water-soluble polymer in water to provide a polymeric solution;
b2) dispersing the layered-double hydroxide in water to provide a layered-double hydroxide dispersion; and
b3) mixing together quantities of the polymeric solution and layered-double hydroxide dispersion to yield the coating mixture.
   Preparing the coating mixture in this manner allows for a greater degree of control over its composition. Coating mixtures used in the prior art have been prepared by blending together polymerisable acrylic monomers, other polymers and inorganic materials (e.g. clays) in the presence of a solvent and then conducting radical polymerisation of the resulting blend under elevated temperature to yield the polymeric coating mixture. As a consequence, coating mixtures prepared by such in-situ polymerisation techniques are likely to contain a variety of polymeric products, each having different properties (e.g. molecular weight). This necessarily makes it different to prepare multiple batches of coating mixture to the exact same specification. In contrast to this approach, the coating mixtures of the present process can be prepared by mixing together quantities of i) a LDH dispersion, and ii) a polymeric solution prepared by dissolving one or more polymers in a solvent, and thus having a pre-determined properties (e.g. viscosity). The present process also eliminates the risk of generating potentially unwanted (or harmful) side products by uncontrolled radical polymerisation of a complex blend of ingredients.

In an embodiment, the LDH has a platelet morphology, wherein the largest dimension (i.e. the diameter) of the platelet (as determined by TEM or SEM imaging) is 0.01-10 μm. Suitably, the largest dimension of the platelet is 0.01-1 μm.

In an embodiment, the LDH has a platelet morphology, wherein the average particle size is 0.3-10 μm. The average particle size can be determined by measuring the average particle length (i.e. the diameter of the platelet) using TEM or SEM imaging). Suitably, the average particle size of the platelet is 2.5-10 μm. More suitably, the average particle size of the platelet is 3.5-9 μm. Yet more suitably, the average particle size of the platelet is 4-8.5 μm. Most suitable, the average particle size of the platelet is 6.5-8.5 μm.

In an embodiment, the aqueous mixture comprises 1-15 wt % of layered double hydroxide. Suitably, the aqueous mixture comprises 1-10 wt % of layered double hydroxide. More suitably, the aqueous mixture comprises 2-6 wt % of layered double hydroxide. Alternatively, the aqueous mixture may comprise 5-8 wt % of layered double hydroxide.

In an embodiment, the aspect ratio of the layered double hydroxide is at least 10, wherein the aspect ratio is the average diameter of the layered double hydroxide platelet divided by the average thickness of the layered double hydroxide platelet.

In an embodiment, the aqueous mixture comprises 1-20 wt % of water-soluble polymer. Suitably, the aqueous mixture comprises 1-10 wt % of water-soluble polymer.

In an embodiment, the aqueous mixture has a viscosity of 1-1000 cP.

In an embodiment, the aqueous mixture has a total solids content (polymer and LDH) of 1-30 wt %. Suitably, the aqueous mixture has a total solids content of 5-15 wt %. More suitably, the aqueous mixture has a total solids content of 8-12 wt %.

In an embodiment, the aqueous mixture has a total solids content of 5-15 wt %, wherein the weight ratio of water-soluble polymer (e.g. PVA) to LDH within the aqueous mixture is 0.5:1 to 5:1. Suitably, the aqueous mixture has a total solids content of 5-15 wt %, wherein the weight ratio of water-soluble polymer (e.g. PVA) to LDH within the aqueous mixture is 0.75:1 to 4.5:1. More suitably, the aqueous mixture has a total solids content of 5-15 wt %, wherein the weight ratio of water-soluble polymer (e.g. PVA) to LDH within the aqueous mixture is 0.75:1 to 2:1 or 3:1 to 4.5:1.

In an embodiment, the aqueous mixture has a total solids content of 8-12 wt %, wherein the weight ratio of water-soluble polymer (e.g. PVA) to LDH within the aqueous mixture is 0.5:1 to 5:1. Suitably, the aqueous mixture has a total solids content of 8-12 wt %, wherein the weight ratio of water-soluble polymer (e.g. PVA) to LDH within the aqueous mixture is 0.75:1 to 4.5:1. More suitably, the aqueous mixture has a total solids content of 8-12 wt %, wherein the weight ratio of water-soluble polymer (e.g. PVA) to LDH within the aqueous mixture is 0.75:1 to 2:1 or 3:1 to 4.5:1.

The film prepared by the process of the invention may have a laminated structure. In such cases, after step c) and prior to step d), the coated first substrate is contacted with a second substrate, such that the layer of coating mixture is provided between the first and second substrates. In such an embodiment, the wet coating mixture serves as an adhesive to adhere the second substrate to the first substrate. In such embodiments, the polymeric matrix may also comprise a curing agent for the adhesive. In such embodiments, the polymeric matrix may also comprise a curing agent for the adhesive.

Alternatively, a laminated structure may be achieved by using a separate, dedicated adhesive layer. Hence, the process may further comprise the steps of:
e) applying a layer of adhesive to the dried coated first substrate resulting from step d), such that the layer of adhesive is provided on top of the layer applied during step c); and
f) contacting the layer of adhesive applied in step e) with a second substrate.

The second substrate may be selected from polyethylene terephthalate (PET), polyethylene (PE), polypropylene (PP), polyamide, nylon, polylactic acid (PLA) and polyvinyl dichloride (PVDC). The second substrate and the first substrate may be the same or different.

The adhesive may be selected from cellulose acetate, poly(vinyl alcohol) (PVOH), polyvinyl acetate, polyvinyl dichloride (PVDC), polyurethane, an acrylic-based adhesive, an epoxy resin and mixtures thereof. Alternatively, the adhesive may be a copolymer based on one or the aforementioned polymers and one or more additional comonomers, such as ethylene (e.g. polyethylene vinyl alcohol). Suitably, the adhesive is food-grade. Suitably, the adhesive may also comprise a curing agent.

In an embodiment, the adhesive may be a polyurethane and/or acrylic-based adhesive.

In an embodiment, the process comprises a step e′) of coating the dried layer of coating mixture resulting from step d) with a further layer of aqueous coating mixture, and then drying the further layer of aqueous coating mixture. Step e′) may be repeated multiple times to afford a substrate containing a plurality of individually coated layers. It will be appreciated that each coating layer may be the same or different.

In an embodiment, the layered double hydroxide has a structure according to formula (I) shown below:

[M^{z+}₁₋ₓM′^{y+}ₓ(OH)₂]^{a+}(Xⁿ⁻¹)ₘ.bH₂O (I)

wherein
M is at least one charged metal cation;
M′ is at least one charged metal cation different from M;
z is 1 or 2;
y is 3 or 4;
0<x<0.9;
0<b≤10;
X is at least one anion;
n is the charge on anion X;
a is equal to z(1-x)+xy-2; and
m≥a/n.

The anion X in the LDH may be, for example, a halide (e.g., chloride), an inorganic oxyanion (e.g. X′ₘOₙ(OH)ₚ^{-q}; m=1-5; n=2-10; p=0-4, q=1-5; X′=B, C, N, S, P: e.g. carbonate, bicarbonate, hydrogenphosphate, dihydrogenphosphate, nitrite, borate, nitrate, phosphate, sulphate), an anionic chromophore, and/or an anionic UV absorber (for example 4-hydroxy-3-10 methoxybenzoic acid, 2-hydroxy-4 methoxybenzophenone-5-sulfonic acid (HMBA), 4-hydroxy-3-methoxy-cinnamic acid, p-aminobenzoic acid and/or urocanic acid).

It will be understood that more than one anion X may be present within the formula (I).

In an embodiment, the anion X is an inorganic oxyanion selected from carbonate, bicarbonate, hydrogenphosphate, dihydrogenphosphate, nitrite, borate, nitrate, phosphate and sulphate. Most suitably, X is carbonate.

In an embodiment, when z is 2, M is Mg, Zn, Fe, Ca, Sn, Ni, Cu, Co, or a mixture of two or more of these, or when z is 1, M is Li. Suitably, z is 2 and M is Ca, Mg, Zn or Fe. More suitably, z is 2 and M is Ca, Mg or Zn.

In an embodiment, when y is 3, M′ is Al, Ga, In, Fe, Ti, or a mixture thereof, or when y is 4, M′ is Sn, Ti or Zr or a mixture thereof. Suitably, y is 3. More suitably, y is 3 and M′ is Al.

In an embodiment, x has a value according to the expression 0.18<x<0.9. Suitably, x has a value according to the expression 0.18<x<0.5. More suitably, x has a value according to the expression 0.18<x<0.4.

In an embodiment, the LDH of formula (I) is a Zn/Al, Mg/Al, ZnMg/Al, Ca/Al, Ni/Al or Cu/Al layered double hydroxide.

In an embodiment, M is Ca, Mg, Zn or Fe, M′ is Al, and X is carbonate, bicarbonate, nitrate, nitrite, or a mixture thereof. Suitably, M is Ca, Mg or Zn, M′ is Al, and X is carbonate, bicarbonate, nitrate, nitrite, or a mixture thereof. More suitably, M is Ca, Mg or Zn, M′ is Al, and X is carbonate.

In an embodiment, the LDH is a Mg₄Al—CO₃ LDH.

The LDH of formula (I) may be prepared by a process comprising the steps of:
i) precipitating a layered double hydroxide having the formula (II) from an aqueous solution containing cations of the metals M and M′, the anion(s) Xⁿ⁻, and optionally an ammonia-releasing agent;

[M^{z+}₁₋ₓM′^{y+}ₓ(OH)₂]^{a+}(Xⁿ⁻)ₘ.bH₂O (II)
wherein M, M′, z, y, x, a, b and X are as defined for formula (I)
ii) ageing the layered double hydroxide precipitate obtained in step (i) in the reaction mixture of step (i);
iii) collecting the aged precipitate resulting from step (ii), then washing it with water; and
iv) drying/filtering the washed precipitate.

The ammonia-releasing agent used in step i) may increase the aspect ratio of the resulting LDH platelets. Suitable ammonia-releasing agents include hexamethylene tetraamine (HMT) and urea. Suitably, the ammonia-releasing agent is urea. The amount of ammonia-releasing agent used in step i) may be such that the molar ratio of ammonia-releasing agent to metal cations (M +M′) is 0.5:1 to 10:1 (e.g. 1:1 to 6:1 or 4:1 to 6:1).

In an embodiment, in step i), the precipitate is formed by contacting aqueous solutions containing cations of the metals M and M′, the anion Xⁿ⁻, and optionally an ammonia-releasing agent, in the presence of a base being a source of OH⁻ (e.g. NaOH, NH₄OH, or a precursor for OH⁻ formation). Suitably the base is NaOH. In an embodiment, the quantity of base used is sufficient to control the pH of the solution at 6.5-14. Suitably, the quantity of base used is sufficient to control the pH of the solution at 7.5-13. More suitably, the quantity of base used is sufficient to control the pH of the solution at 9-11.

In an embodiment, in step ii), the layered double hydroxide precipitate obtained in step i) is aged in the reaction mixture of step i) for a period of 5 minutes to 72 hours at a temperature of 25-180° C.

Suitably, in step ii), the layered double hydroxide precipitate obtained in step i) is aged in the reaction mixture of step i) for a period of 0.5 to 72 hours. More suitably, in step ii), the layered double hydroxide precipitate obtained in step i) is aged in the reaction mixture of step i) for a period of 5 to 48 hours. Most suitably, in step ii), the layered double hydroxide precipitate obtained in step i) is aged in the reaction mixture of step i) for a period of 12 to 36 hours.

Suitably, in step ii), the layered double hydroxide precipitate obtained in step i) is aged in the reaction mixture of step i) at a temperature of 80-180° C. More suitably, in step ii), the layered double hydroxide precipitate obtained in step i) is aged in the reaction mixture of step i) at a temperature of 90-150° C.

Step ii) may be performed in an autoclave.

In an embodiment, in step iii), the aged precipitate resulting from step ii) is collected, then washed with water until the filtrate has a pH in the range of 6.5-7.5.

Step c) of the present process may be performed by various different techniques.

In one embodiment, the aqueous coating mixture may be applied to the substrate in step c) by spraying, dip coating or spin coating.

Alternatively, the aqueous coating mixture may be applied to the substrate in step c) using a bath-and-roller assembly. Such assemblies will be understood to comprise a rotating roller being in partial contact with a bath containing a coating mixture. As the roller rotates, the coating mixture coats the surface of the roller, and is transferred onto a substrate passing over the surface of the roller. Additional rollers may be present to meter the quantity of coating mixture applied to the substrate, or to remove excess coating mixture. Such assemblies may additionally comprise a Mayer rod, or other means, to ensure uniform distribution of the coating mixture across the surface of the substrate.

### Films

As discussed hereinbefore, the present invention also provides a film obtainable, obtained or directly obtained by a process as defined herein

As discussed hereinbefore, the present invention also provides a film comprising:
a) a substrate; and
b) a coating layer provided on a least one surface of the substrate,
   wherein the coating layer comprises 5-70wt % of layered double hydroxide dispersed throughout a water-soluble polymeric matrix.

The films of the invention have improved OTR and WVTR properties with respect to prior art films.

It will be understood that the films of the invention are distinguished from LbL-prepared films by virtue of the fact that they do not contain a plurality of alternating layers of polymer and LDH. Rather, the films of the invention contain a single layer of LDH dispersed throughout a polymeric matrix. The LDH may be randomly dispersed throughout the polymeric matrix.

In an embodiment, the coating layer comprises 10-60 wt % of layered double hydroxide. Suitably, the coating layer comprises 20-50 wt % of layered double hydroxide.

In an embodiment, the weight ratio of water-soluble polymeric matrix (e.g. PVA) to LDH within the coating layer is 0.5:1 to 5:1. Suitably, the weight ratio of water-soluble polymeric matrix (e.g. PVA) to LDH within the coating layer is 0.75:1 to 4.5:1. More suitably, the weight ratio of water-soluble polymeric matrix (e.g. PVA) to LDH within the coating layer is 0.75:1 to 2:1 or 3:1 to 4.5:1.

In an embodiment, the LDH is as described in any of the paragraphs appearing hereinbefore in relation to the process for preparing the film.

In an embodiment, the polymeric matrix comprises an water-soluble polymer as described in any of the paragraphs appearing hereinbefore in relation to the process for preparing the film.

In an embodiment, the substrate is as described in any of the paragraphs appearing hereinbefore in relation to the process for preparing the film.

In an embodiment, the coating layer has a thickness of 0.1-10 μm (e.g. 1-10 μm).

In an embodiment, the film comprises multiple coating layers. Suitably, the film comprises 1-10 individually coated layers. Suitably, the film comprises 1-4 individually coated layers.

In an embodiment, the coating layer comprises:
a) 10-60 wt % of layered double hydroxide;
b) 40-90 wt % of polymeric matrix; and
c) 0-2 wt % of water.

In an embodiment, the coating layer comprises:
a) 10-60 wt % of layered double hydroxide;
b) 40-90 wt % of poly(vinyl alcohol); and
c) 0-2 wt % of water.

The film may have a laminated structure. Hence, in one embodiment, the substrate is a first substrate, and the film comprises a second substrate disposed on top of the coating layer, such that the coating layer is located between the first and second substrates. In such embodiments, the coating layer serves as an adhesive to adhere the second substrate to the first substrate.

Alternatively, the film comprises a layer of adhesive provided between the coating layer and the second substrate. In such embodiments, a dedicated adhesive layer adheres the second substrate to the coated first substrate.

The second substrate may be as described in any of the paragraphs appearing hereinbefore in relation to the process for preparing the film.

The adhesive may be as described in any of the paragraphs appearing hereinbefore in relation to the process for preparing the film.

### Applications of the Film

As discussed hereinbefore, the present invention also provides a use of a film as defined herein in packaging.

As discussed hereinbefore, the present invention also provides a container comprising a film as defined herein.

The advantageous OTR and WVTR properties of the films of the invention render them useful in the field of packaging, particularly in the food industry. Accordingly, the films of the invention may be used in packaging or in a container that is intended to package or contain a foodstuff.

### EXAMPLES

The present invention will now be described, for the purpose of illustration only, with reference to the accompanying figures, in which:

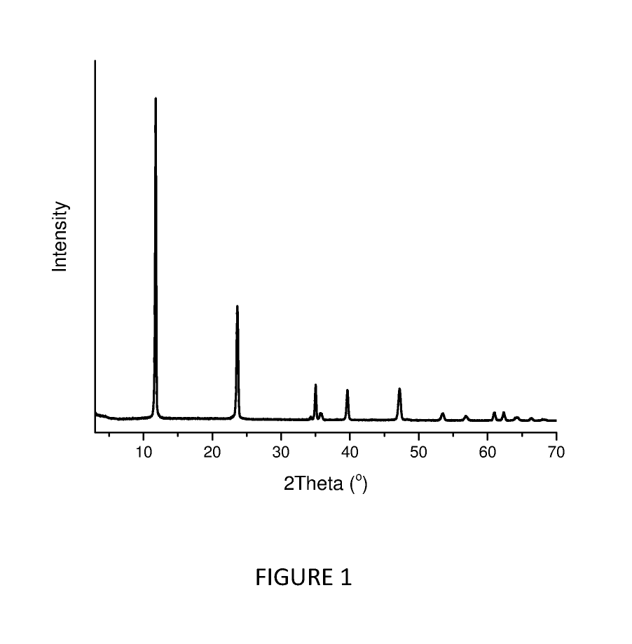

FIG. 1 shows X-ray powder crystallography for the LDHs of Example 1.

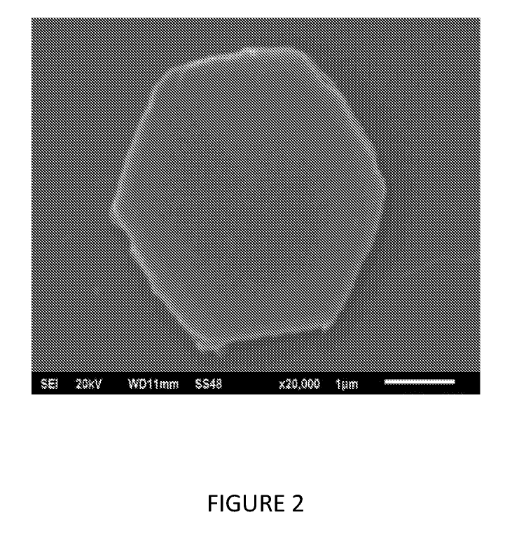

FIG. 2 shows an SEM image of the LDHs of Example 1.

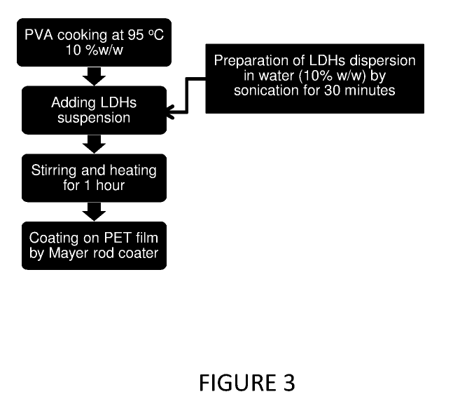

FIG. 3 shows a schematic flow diagram outlining the coating process.

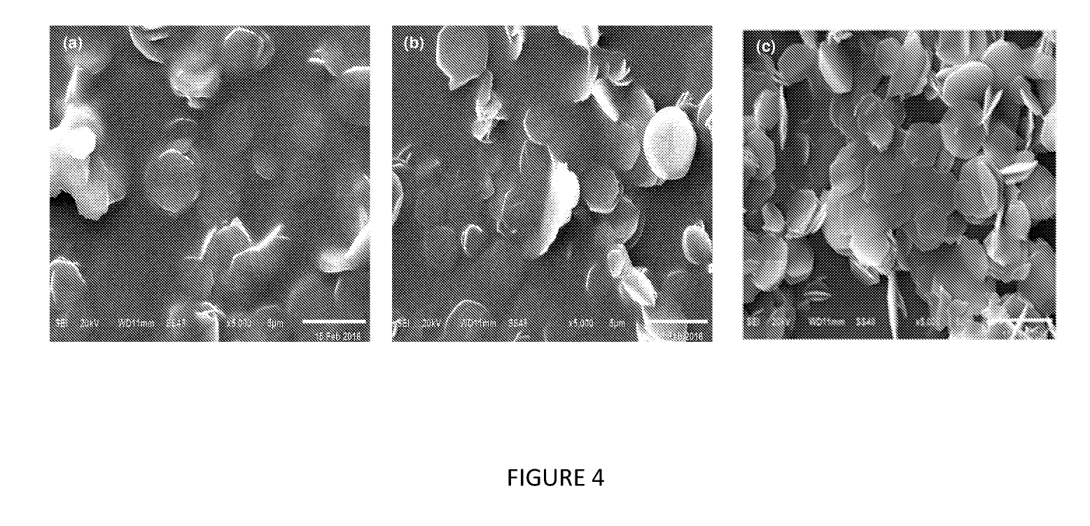

FIG. 4 shows SEM images of coated films having (a) 2%, (b) 3.3% and (c) 5% loading of LDHs in the coating formulation (Table 1 coating mixtures).

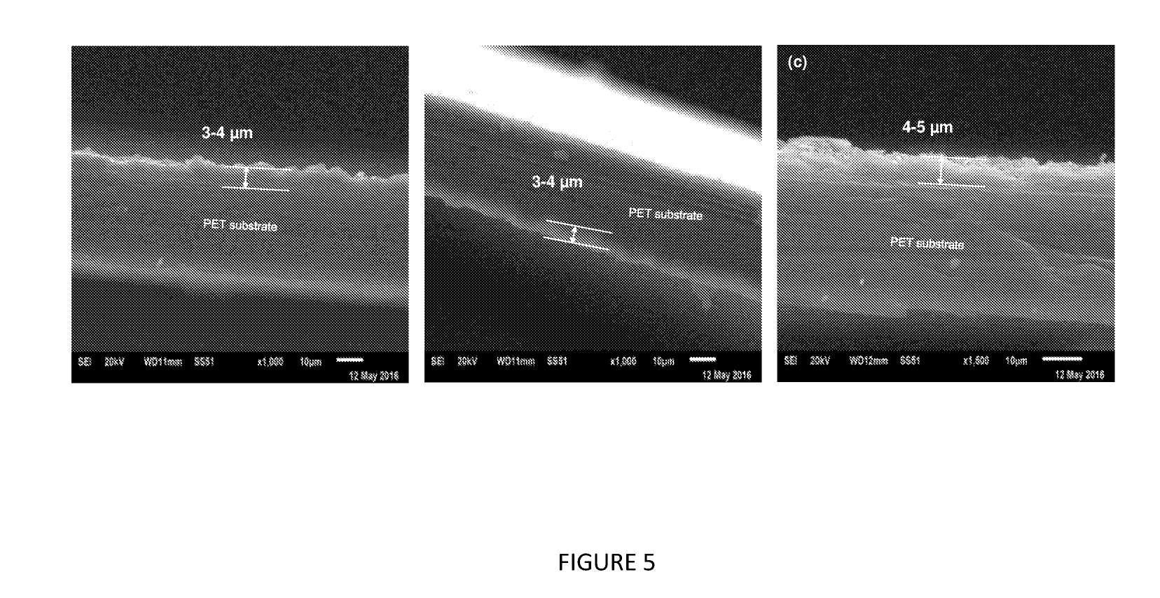

FIG. 5 shows cross-sectional SEM images of coated films having (a) 2%, (b) 3.3% and (c) 5% loading of LDHs in the coating formulation (Table 1 coating mixtures).

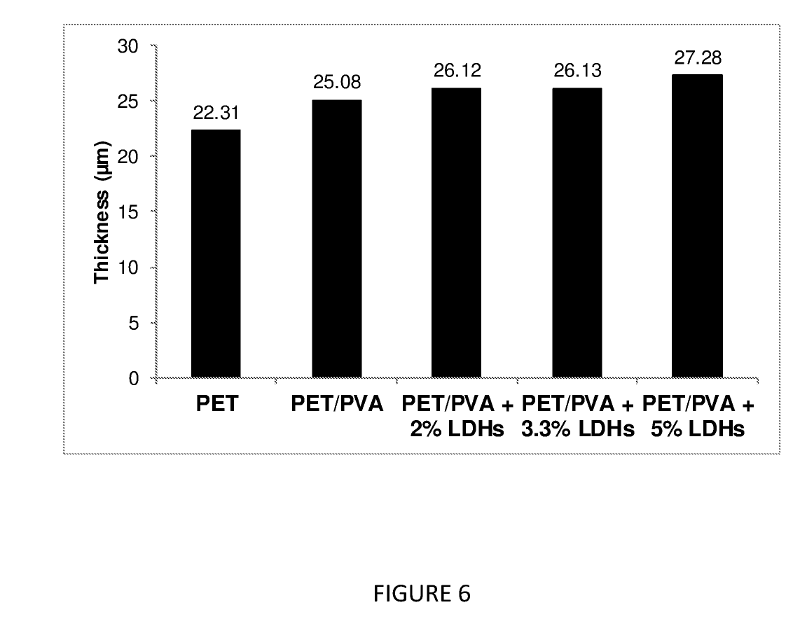

FIG. 6 shows thickness measurements of various coated and uncoated films (Table 1 coating mixtures).

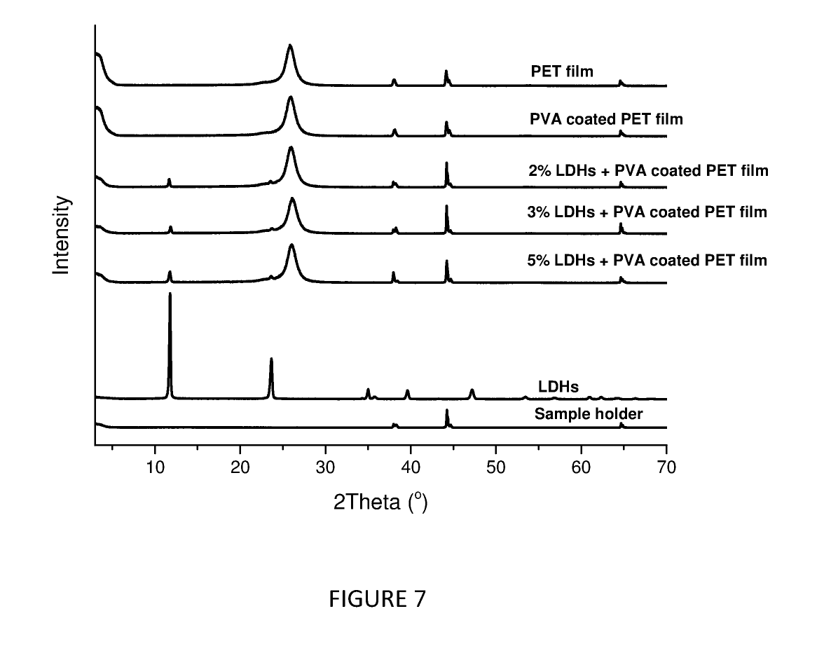

FIG. 7 shows X-ray powder crystallography of various coated and uncoated films, as well as that of the LDHs themselves (Table 1 coating mixtures).

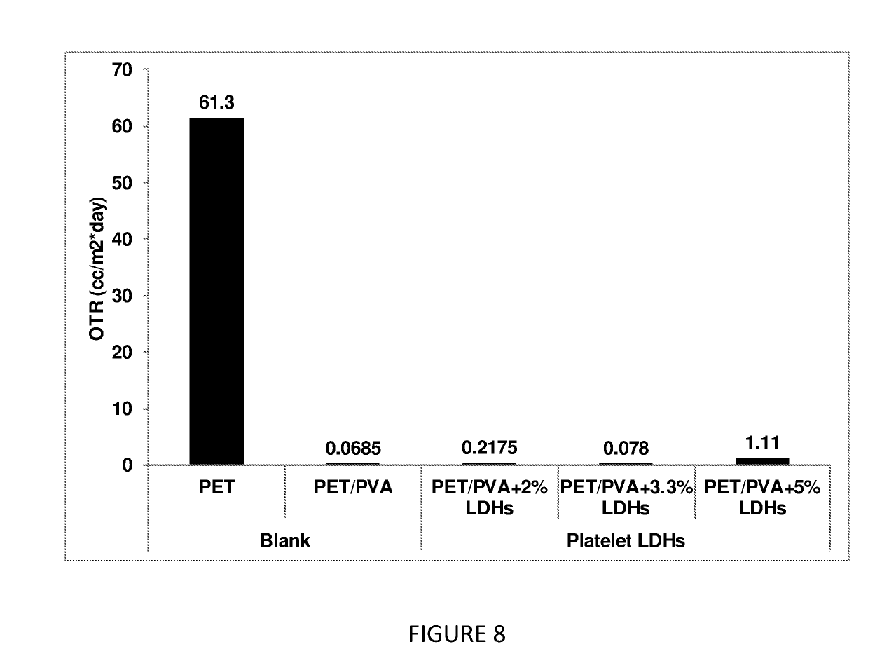

FIG. 8 shows oxygen transmission rate values (OTR) of various coated and uncoated films (Table 1 coating mixtures).

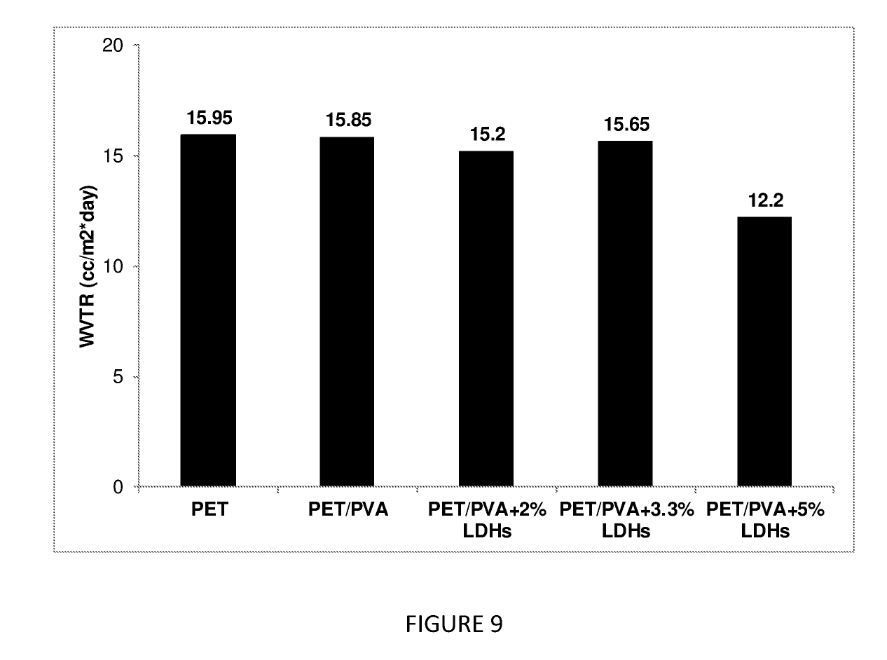

FIG. 9 shows water vapour transmission rate values (WVTR) of various coated and uncoated films (Table 1 coating mixtures).

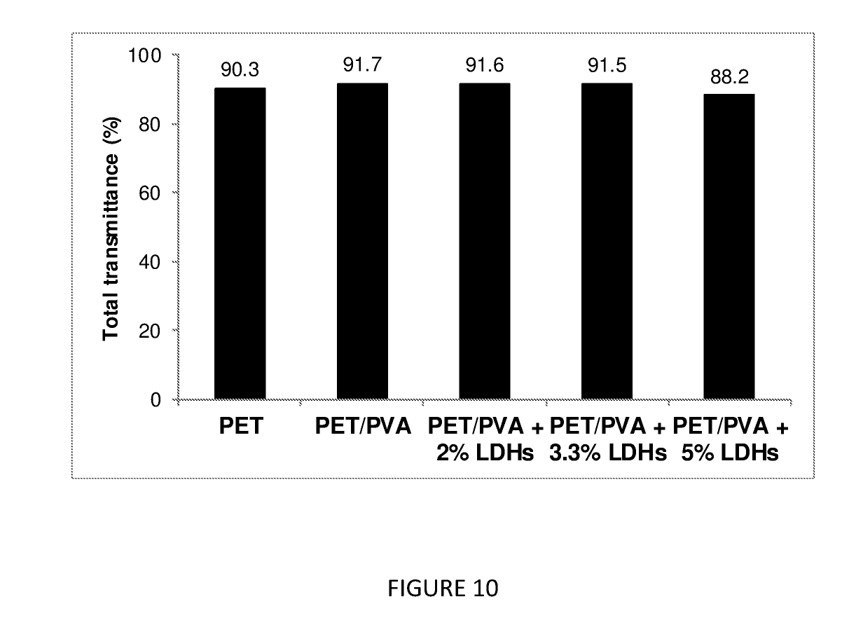

FIG. 10 shows the total transmittance values of various coated and uncoated films (Table 1 coating mixtures).

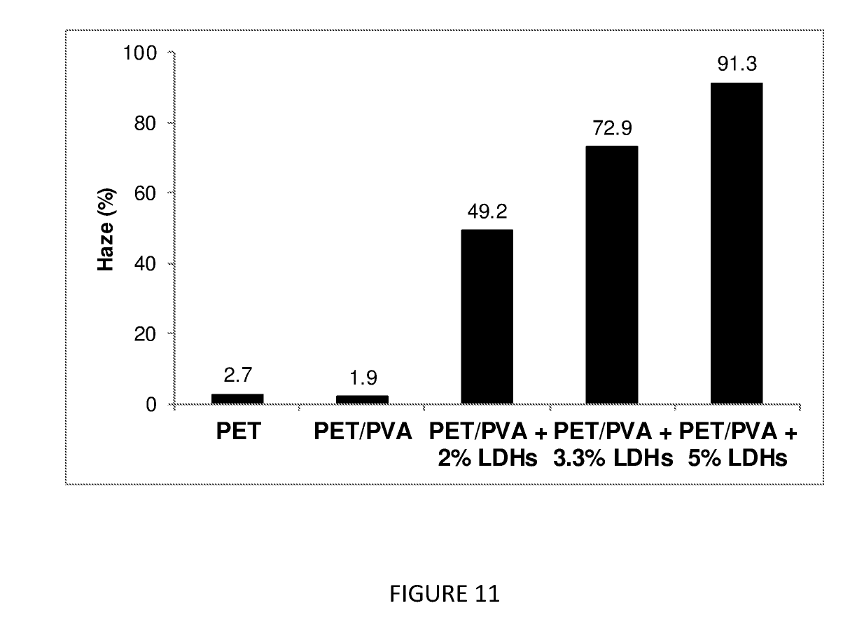

FIG. 11 shows the haze values of various coated and uncoated films (Table 1 coating mixtures).

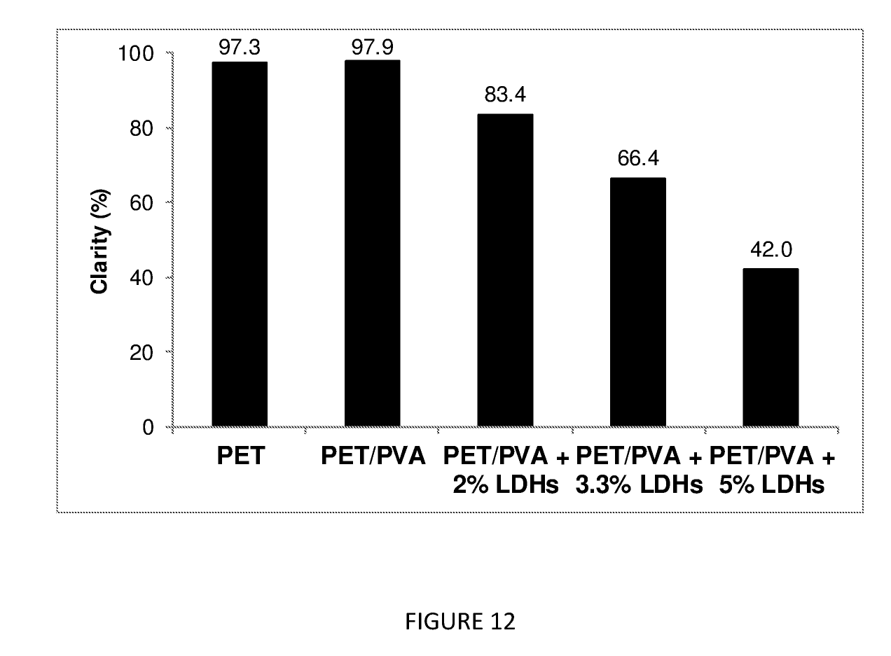

FIG. 12 shows the clarity values of various coated and uncoated films (Table 1 coating mixtures).

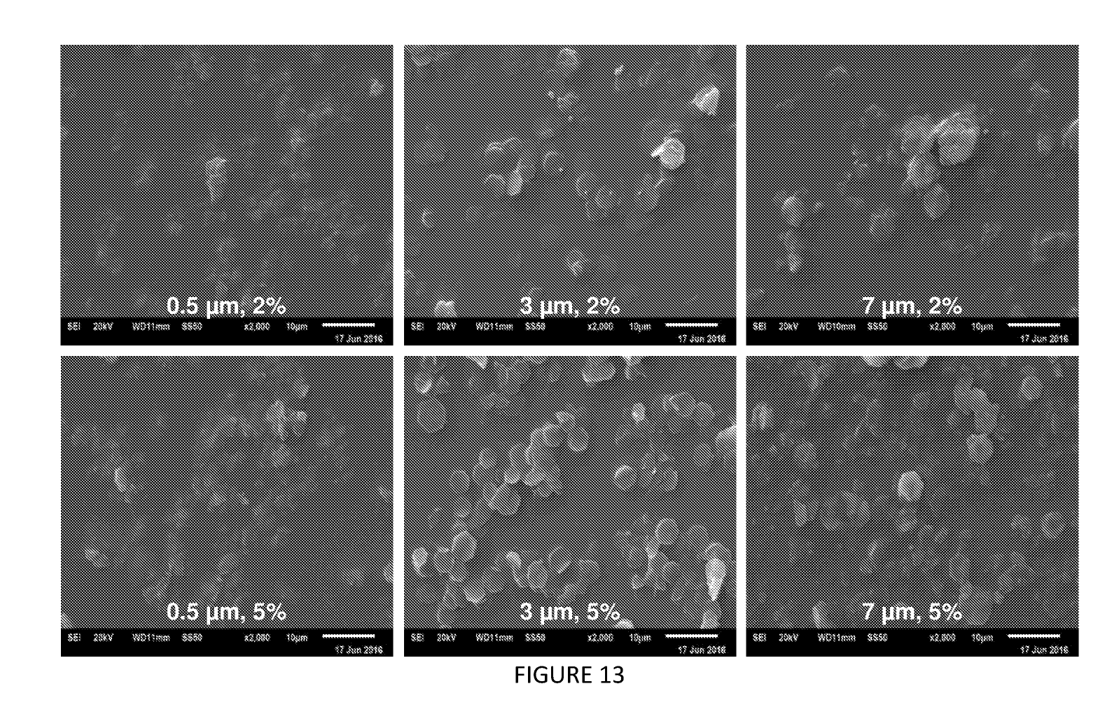

FIG. 13 shows SEM images of various coated films (Table 2 coating mixtures).

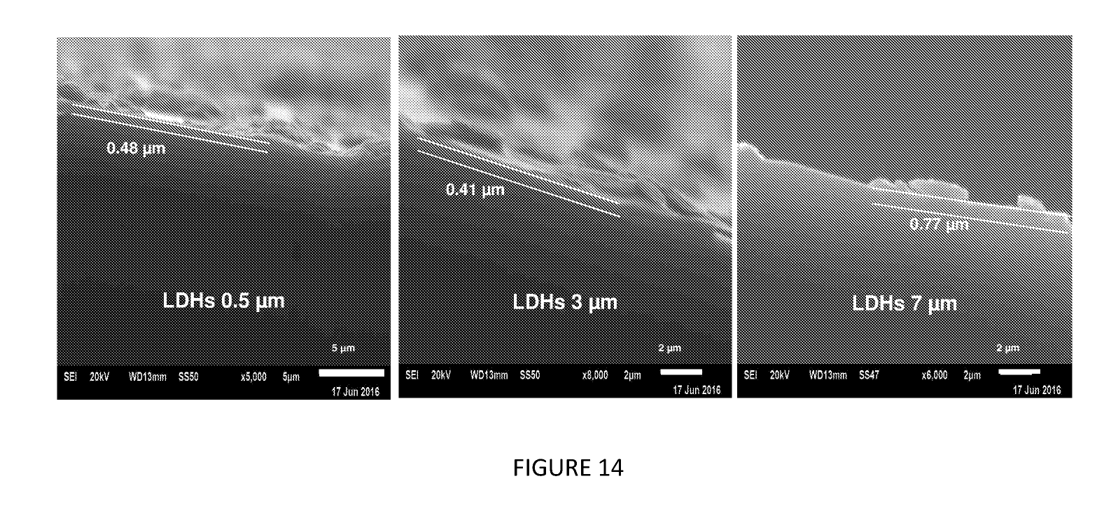

FIG. 14 shows cross-sectional SEM images of coated films at 5% LDH loading (Table 2 coating mixtures).

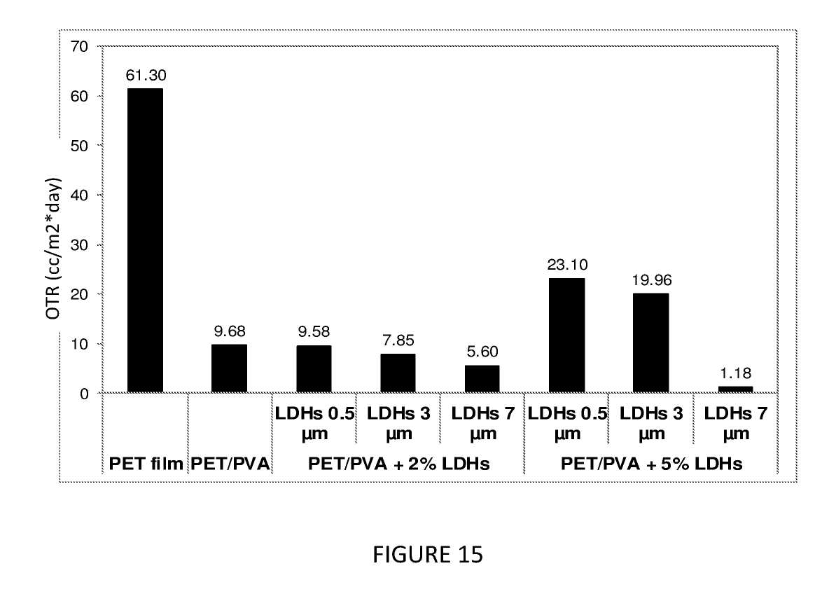

FIG. 15 shows oxygen transmission rate values (OTR) of various coated and uncoated films (Table 2 coating mixtures).

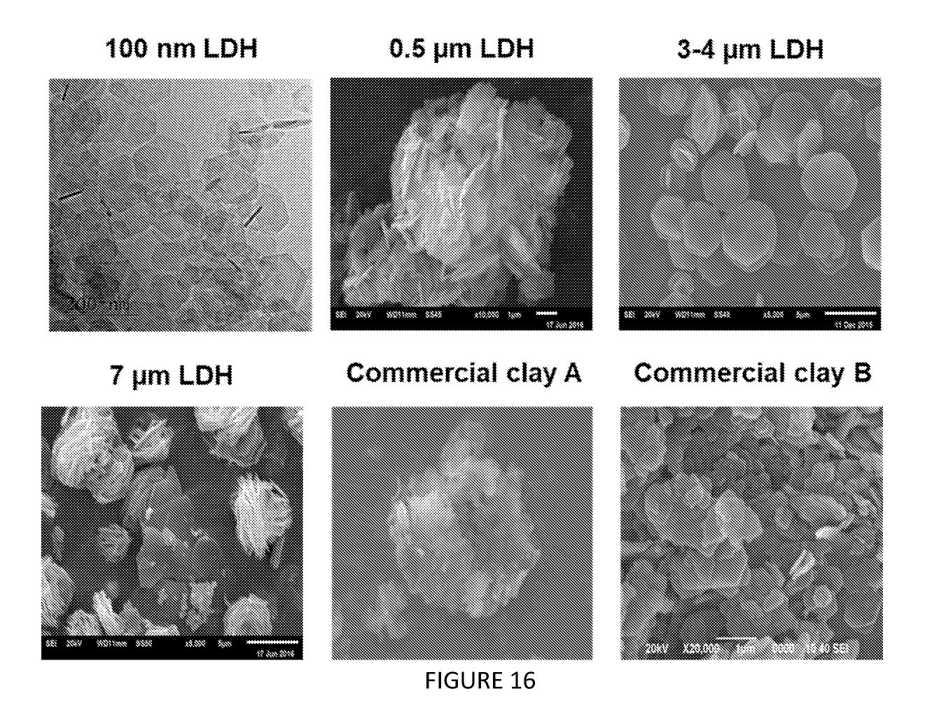

FIG. 16 shows TEM image (for 100 nm LDH) and SEM images of the LDHs and commercial clays used in Example 5.

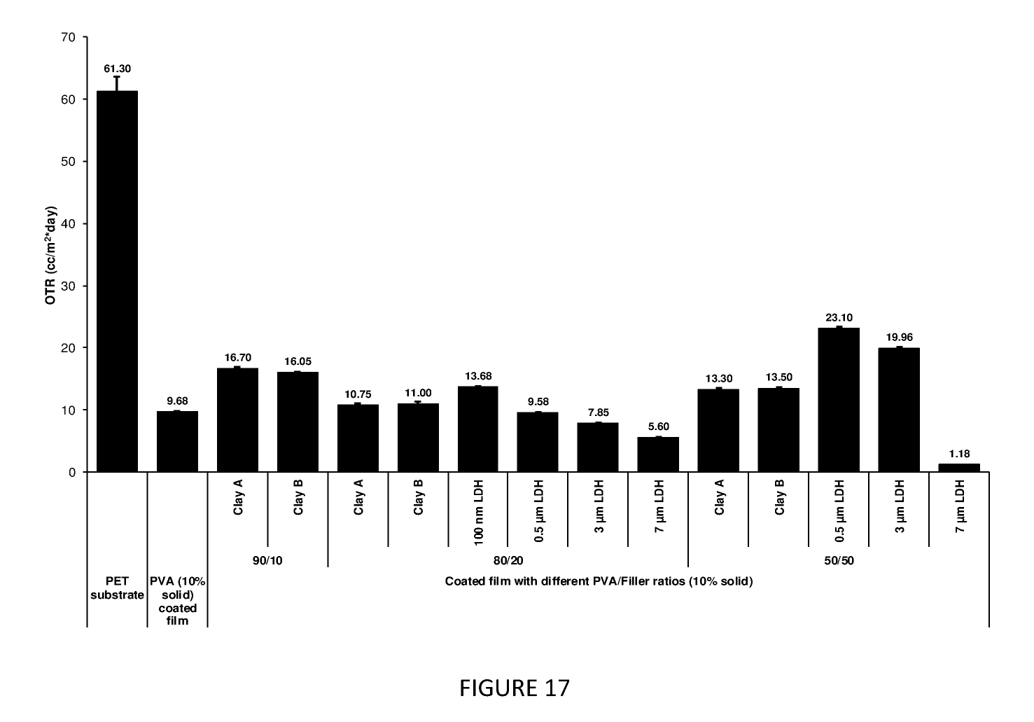

FIG. 17 shows oxygen transmission rate values (OTR) of the various coated and uncoated films of Example 5.

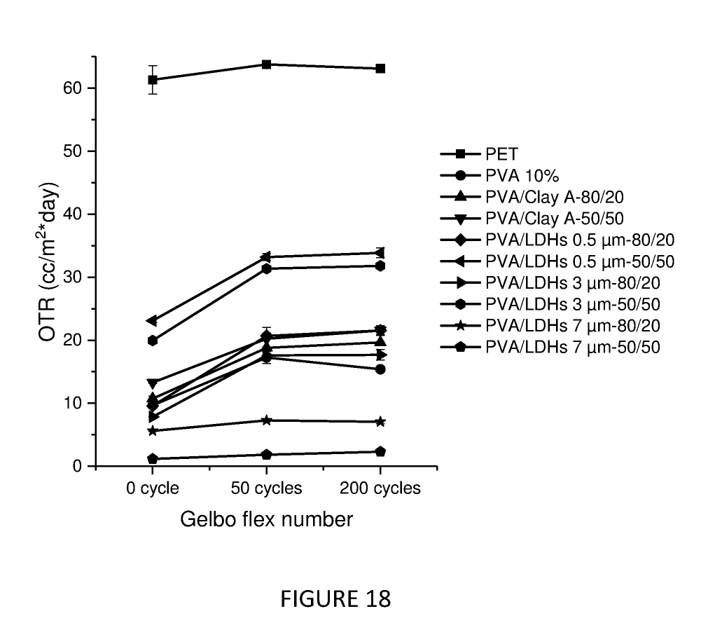

FIG. 18 shows the effect of flex testing on the oxygen transmission rate values (OTR) of the various coated and uncoated films of Example 5.

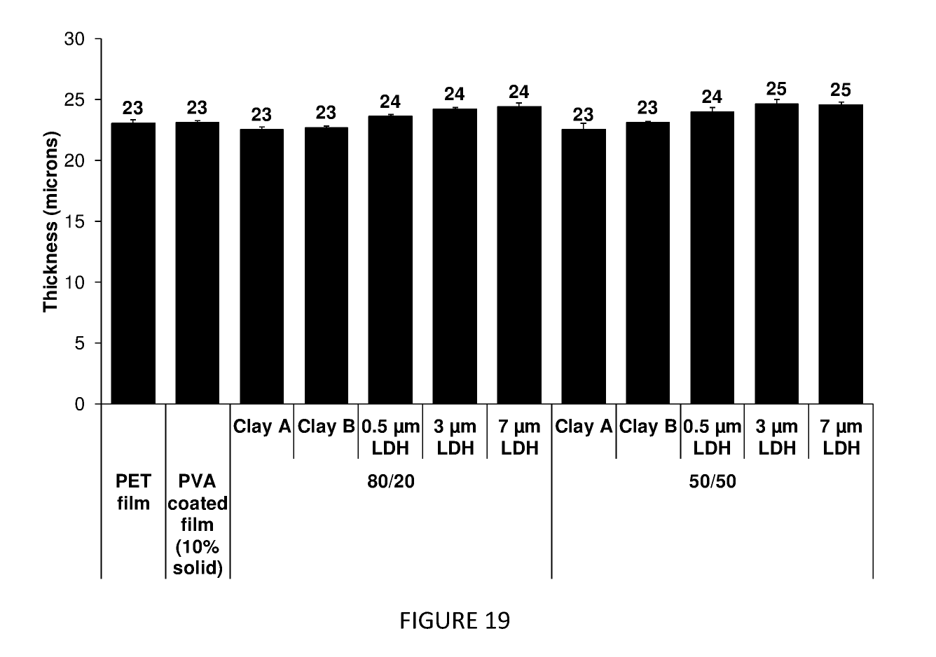

FIG. 19 shows the thickness of the various coated and uncoated films of Example 5.

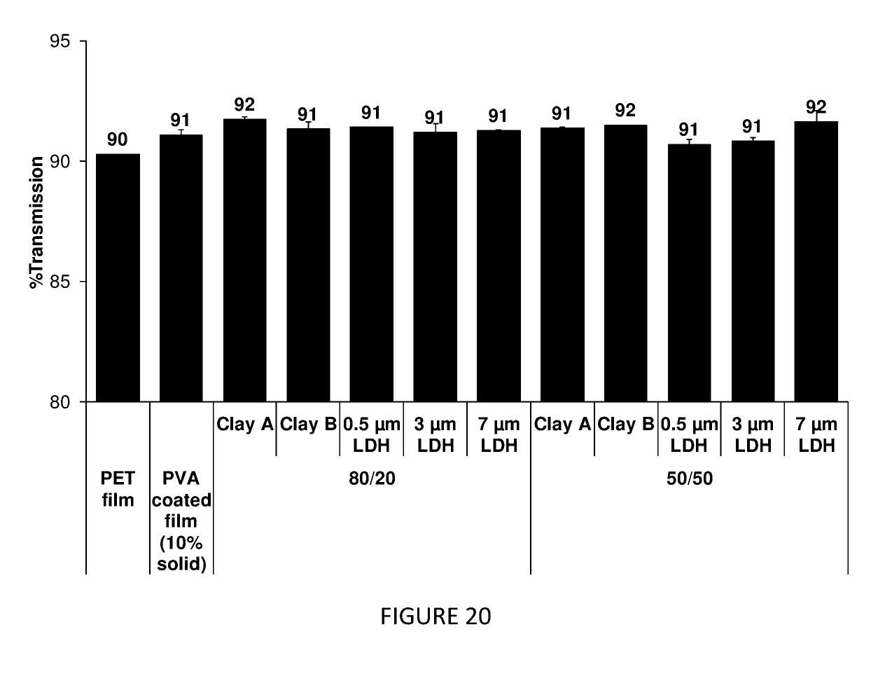

FIG. 20 shows the total transmittance values of the various coated and uncoated films of Example 5.

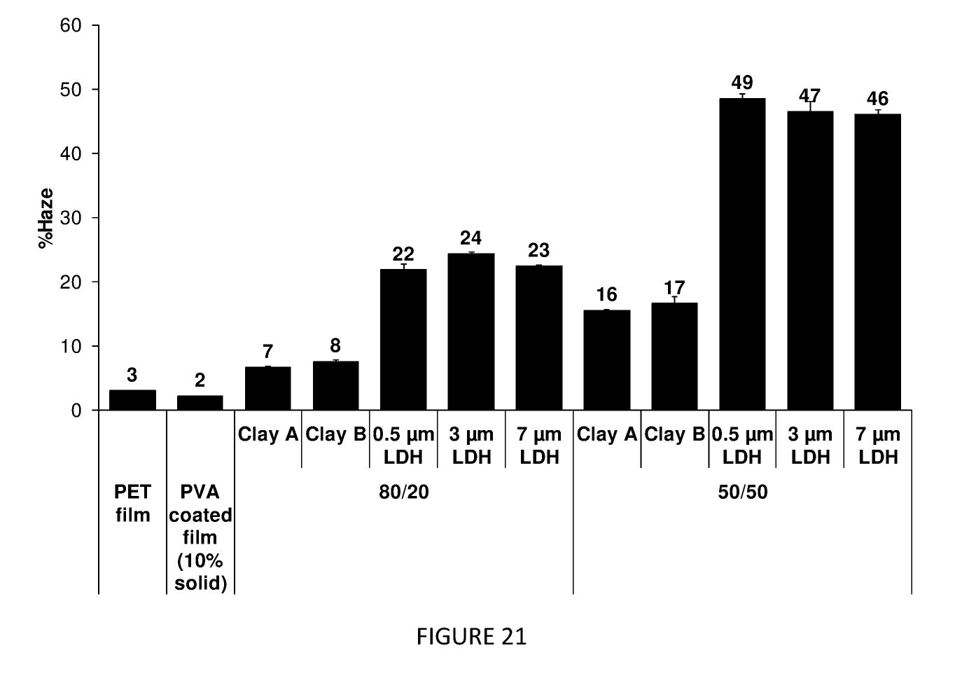

FIG. 21 shows the haze values of the various coated and uncoated films of Example 5.

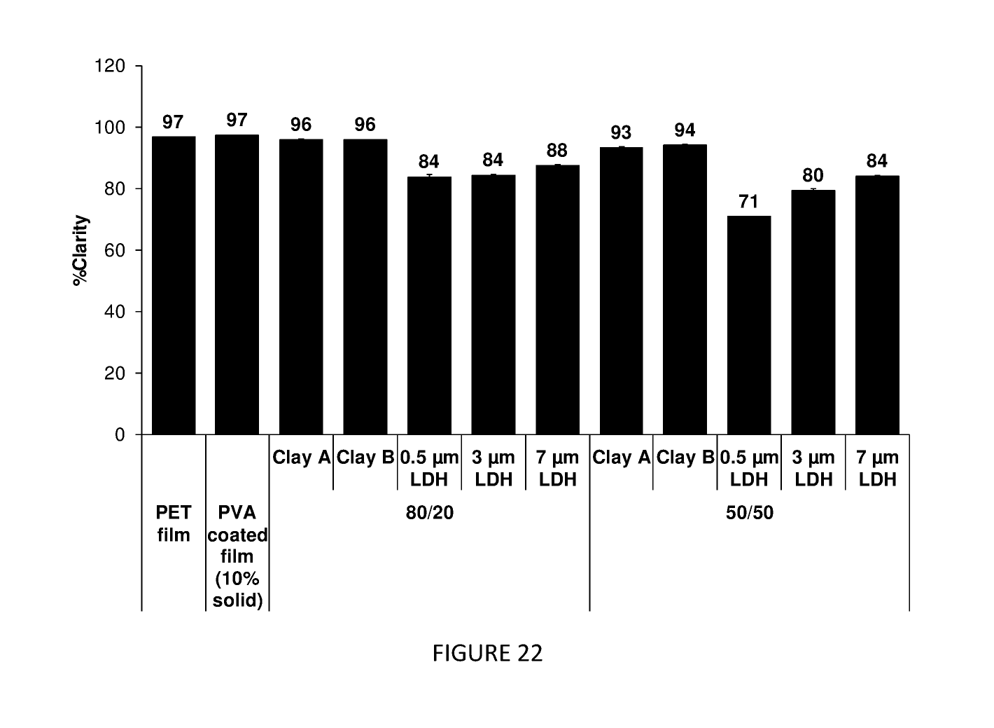

FIG. 22 shows the clarity values of the various coated and uncoated films of Example 5.

### MATERIALS AND METHODS

### Powder X-Ray Diffraction (PXRD)

X-ray diffraction (XRD) patterns were recorded on a PANalytical X′Pert Pro instrument in reflection mode with Cu Ka radiation. The accelerating voltage was set at 40 kV with 40 mA current (λ=1.542°) at 0.01°s⁻¹ from 1° to 70° with a slit size of ¼ degree.

### Scanning Electron Microscopy (SEM)

Scanning electron microscopy (SEM) analyses were performed on a JEOL JSM 6100 scanning microscope with an accelerating voltage of 20 kV. Powder samples are spread and film samples are mounted on carbon tape adhered to an SEM stage. For cross-sectional SEM, film samples are cut by a sharp blade and mounted on carbon tape adhered to 90o sample holder. Before observation, the samples are sputter coated with a thick Platinum layer to prevent charging and to improve the image quality.

### Transmission Electron Microscopy (TEM)

Transmission electron microscopy (TEM) was conducted at the Research Complex at Harwell, Oxfordshire on Jeol JEM-2100 TEM equipped with LaB6 filament at an accelerating voltage of 200 kV. Prior to analysis, samples were diluted with deionised water and sonicated in deionised water for 15 minutes. A few droplets of the resulting suspension were left to dry on a copper grid covered with a carbon film (300 mesh, Agar scientific).

### Oxygen Transmission Rate Testing

Films and coated substrates are tested for oxygen transmission rate using an oxygen permeation analyser (Systech Illinois Inc., Oxygen Permeation Analyser 8001) at 23° C. and 0% RH. The oxygen transmission rate (OTR) is recorded after a steady state permeation is reached and reported in units of cc/m²·day·atm.

### Water Vapour Transmission Rate Testing

Films and coated substrates are tested for water vapour transmission rate using a water vapour permeation analyser (Systech Illinois Inc., Water Vapour Permeation Analyser 7000) at 38° C. and 90% RH. The water vapour transmission rate (OTR) is recorded after a steady state permeation is reached and reported in units of cc/m²·day·atm.

### Thickness Measurements

All thickness measurements are tested by using a thickness tester (Thwing-Albert Instrument Company, ProGage Thickness Tester). Average of ten measurements is reported in units of micron.

### Optical Properties Measurements

Total transmittance, haze, and clarity of films are measured by using a haze meter (The haze-gard I, BYK-Gardner GmbH Inc). Average of ten measurements is reported in units of percent.

### Flex Durability Measurements

Flex durability measurement of flexible films was adapted from ASTM F392-93, using Gelbo flex tester, IDM Instruments, at SCG Packaging, Thailand. Film samples were cut to a size of 200 mm (width)×280 mm (long). The sample was then clamped tightly to the stationary mandrel and the moving mandrel of the instrument. Flexing was done at room temperature with a twisting motion, repeatedly twisting and crushing the film for a certain cycle. After flexing, OTR was performed to observed the change of OTR values.

### Example 1

### Synthesis of LDHs

An aqueous solution (100 mL) of 0.40 M Mg(NO₃)₂.6H₂O, 0.10 M of Al(NO₃)₃.9H₂O, and 0.80 M urea was prepared. The mixed solution were transferred to a Teflon-lined autoclave and heated in an oven at the 100° C. for 24 hours. After the reactions were cooled to room temperature, the precipitate products were washed several times with deionised water by filtration and finally placed in a vacuum oven overnight. The LDHs product shows typical XRD patterns (FIG. 1) of well-crystallised LDHs with an average size of 3-4 μm and aspect ratio at about 80. FIG. 2 shows an SEM image of the prepared LDH.

### Example 2

### Preparation of Coating Mixture

An aqueous barrier coating solution is prepared as follows. An aqueous polyvinyl alcohol (PVA) solution of defined solid content is freshly prepared; the required amount of polymer is weighed, added to the required amount of pre-heated deionised water under vigorous stirring. The mixture is stirred and heated at 90° C. After complete dissolution of polymer, the PVA solution is kept at 60° C. under stirring. PVA can be chosen from different molecular weights and degree of hydrolysis (POVAL 28-99, MW 145,000 g/mol, 99-99.8% hydrolysis, Kuraray; Mowiol 4-88, MW 31,000, 88% hydrolysis, Sigma-Aldrich) and used as received.

LDH is firstly added to the deionised water to prepare a 10% of filler suspension. The suspension is stirred for 10 minutes and sonicated for 20-30 minutes before usage. The LDH and PVA solutions of different proportions are vigorously mixed to obtain the coatings with weight ratios of PVA/LDHs, and the obtained coatings are stirred at 60° C. for 1 hour. The solid part of the coating formulations are controlled at 10%.

Several solutions (Table 1) are formulated using 3-4 μm size LDHs. Alternatively, the coating mixtures can be prepared with LDHs having size of 0.5 or 7 μm and formulated similarly to above procedure (Table 2).

TABLE 1
Coating formulation of 3-4 μm size LDHs with high molecular
weight PVA

| | | |
|---|---|---|
| Part (%) | % LDHs | PVA/LDHs |

| PVA* | LDHs^{†} | loading | ratio |
|---|---|---|---|
| 80 | 20 | 2 | 4 |
| 67 | 33 | 3.3 | 2 |
| 50 | 50 | 5 | 1 |

*M_{w} 145,000, 99-99.8% hydrolysis
^{†}3-4 μm in size, MgAl—CO₃-LDHs (Mg/Al = 4)

TABLE 2
Coating formulation of low molecular weight PVA with various
sizes of LDHs (0.5, 3 and 7 μm)

| | | |
|---|---|---|
| Part (%) | % LDHs | PVA/LDHs |

| PVA* | LDHs^{†} | loading | ratio |
|---|---|---|---|
| 80 | 20 | 2 | 4 |
| 50 | 50 | 5 | 1 |

*M_{w} 31,000, 88% hydrolysis
^{†}0.5, 3 and 7 μm in size, MgAl—CO₃-LDHs (Mg/Al = 4)

### Example 3

### Preparation of Coated Films

FIG. 3 provides a schematic flow diagram of the coating process.

The coating solution is applied to corona-treated polyethylene terephthalate substrate (SARAFIL Transparent TF101, Polyplex Thailand), which is supplied by SCG Packaging PLC, by a Mayer rod coater and an automatic coater (K101, RK Print Coat Instruments Ltd.). The substrate film is secured in the middle of the coating area and the rod is placed on the upper top of the film. Approximately 1-2 mL of the prepared coating solution is applied in the gap between the rod and the substrate along the width of the substrate. A Mayer rod moves down the substrate with a controlled speed and the coated film is obtained. All coated samples are dried naturally at room temperature. Coating thickness is controlled by selecting of the rod number and speed of the coated.

### Example 4

### Characterisation of Coated and Uncoated Films

Films Coated with Table 1 Coating Mixtures

FIG. 4 shows SEM images of coated films having (a) 2%, (b) 3.3% and (c) 5% loading of LDHs in the coating formulation.

FIG. 5 shows cross-sectional SEM images of coated films having (a) 2%, (b) 3.3% and (c) 5% loading of LDHs in the coating formulation.

FIG. 6 shows thickness measurements of various coated and uncoated films.

FIG. 7 shows X-ray powder crystallography of various coated and uncoated films, as well as that of the LDHs themselves.

FIG. 8 shows oxygen transmission rate values (OTR) of various coated and uncoated films.

FIG. 9 shows water vapour transmission rate values (WVTR) of various coated and uncoated films.

FIG. 10 shows the total transmittance values of various coated and uncoated films.

FIG. 11 shows the haze values of various coated and uncoated films.

FIG. 12 shows the clarity values of various coated and uncoated films.

Films Coated with Table 2 Coating Mixtures

FIG. 13 shows SEM images of various coated films.

FIG. 14 shows cross-sectional SEM images of coated films at 5% LDH loading.

FIG. 15 shows oxygen transmission rate values (OTR) of various coated and uncoated films.

### Example 5

### Comparison of LDH-Containing Coatings and Commercial Clay-Containing Coatings

### Preparation of Coated Substrates

LDH were prepared according to the procedure outlined in Example 1.

Aqueous barrier coating solutions were prepared as follows: an aqueous polyviny alcohol (PVA, Mowiol 4-88, M_{w} 31,000, 88% hydrolysis, Sigma-Aldrich) solution of defined solid content is freshly prepared; the required amount of polymer is weighed, added to the required amount of pre-heated deionised water under vigorous stirring. The mixture then is stirred and heated at 90° C. After complete dissolution of the polymer, the PVA solution is cooled down and kept at room temperature. Suspensions of LDHs and clays were prepared at 10 wt %. in water for 10 minutes and then sonicated for 20-30 minutes before being used. FIG. 16 provides SEM images of the different LDHs and clays used in this study. The LDH/clay and PVA solutions of were vigorously mixed in different proportions to obtain coating solutions with weight ratios of PVA/LDHs or PVA/clay at 80/20 and 50/50. The total solids content of the coating solution was controlled at 10%.

The coating solution was then applied to corona-treated polyethylene terephthalate substrate (SARAFIL Transparent TF101, Polyplex Thailand), which is supplied by SCG Packaging PLC, by a Mayer rod coater and an automatic coater (K101, RK Print Coat Instruments Ltd.). The substrate film is secured in the middle of the coating area and the rod is placed on the upper top of the film. Approximately 1-2 mL of the prepared coating solution is applied in the gap between the rod and the substrate along the width of the substrate. A Mayer rod moves down the substrate with a controlled speed and the coated film is obtained. All coated samples are dried naturally at room temperature. Coating thickness is controlled by using a yellow rod and fixing speed of the coater at #7 for all coatings.

### Oxygen Transmission Rate (OTR) Studies

FIG. 17 presents the OTR properties of the various LDH-containing and clay-containing coated films.

Clay particles are strongly aggregated. In general, a dispersing agent is required to obtain full dispersion of clay in water. To avoid possible unwanted side-effects, such an additive was not included in this study. FIG. 17 shows that the clay-containing samples have poor OTR properties, indicating that using such commercial clays can destroy the barrier performance of the coating layer (possibly due to the poor dispersion of the clay in the PVA solution). On the other hand, FIG. 17 shows that the LDH-containing samples generally gave better OTR results than the clay-containing samples. Particularly good OTR properties were observed for LDHs having a larger platelet size. Without wishing to be bound by theory, it is believed that LDHs of smaller platelet size tend to be aggregated and might therefore be insufficiently covered by PVA, thereby giving rise to a more open coating structure through which oxygen can pass.

Generally, inorganic-coated films (i.e. oxide-coated, clay-coated) have poor flex resistance. OTR measurement was employed to observe the change in barrier property of the coated films before and after 50 and 200 flex cycles. FIG. 18 shows the effect of flex testing on the OTR properties of the various LDH-containing and clay-containing coated films.

The results presented in FIG. 18 show that LDH-containing samples of larger platelet size (e.g. 7 μm) exhibited excellent flex durability, demonstrating good barrier properties even after 200 flexes.

### Optical Studies

FIG. 19 shows a comparison of the thickness of the various LDH-containing and clay-containing coated films. FIGS. 20, 21 and 22 provide a comparison of the light transmittance, haze and clarity of the various films.

The results presented in FIGS. 19-22 show that all of the coated films exhibit similar transparency and thickness. Haze and clarity properties tend to worsen when more LDH/clay is incorporated into the coating layer.

While specific embodiments of the invention have been described herein for the purpose of reference and illustration, various modifications will be apparent to a person skilled in the art without departing from the scope of the invention as defined by the appended claims.

1. A process for the preparation of a film, the process comprising the steps of:
a) providing a first substrate;
b) providing an aqueous mixture comprising a water-soluble polymer and a water-dispersible layered-double hydroxide;
c) coating the first substrate with a layer of the aqueous mixture; and
d) drying the coated first substrate.

2. The process of claim 1, wherein the first substrate is selected from polyethylene terephthalate (PET), polyethylene (PE), polypropylene (PP), polyamide, nylon, polylactic acid (PLA) and polyvinyl dichloride (PVDC).

3. The process of claim 1 or 2, wherein the water-soluble polymer is selected from one or more of poly(vinyl alcohol) (PVOH), copolymers comprising vinyl alcohol (e.g. polyethylene vinyl alcohol (EVOH)) and polyacrylic acid (PAA).

4. The process of any one of claim 1, 2 or 3, wherein the layered double hydroxide has a structure according to formula (I) shown below:
[M^{z+}₁₋ₓM′^{y+}ₓ(OH)₂]^{a+}(Xⁿ⁻)ₘ.bH₂O (I)
wherein
M is at least one charged metal cation;
M′ is at least one charged metal cation different from M;
z is 1 or 2;
y is 3 or 4;
0<x<0.9;
0<b≤10;
X is at least one anion;
n is the charge on anion X;
a is equal to z(1-x)+xy-2; and
m≥a/n.

5. The process of claim 4, wherein when z is 2, M is Mg, Zn, Fe, Ca, Sn, Ni, Cu, Co, or a mixture of two or more of these, or when z is 1, M is Li.

6. The process of claim 4 or 5, wherein when y is 3, M′ is Al, Ga, In, Fe, Ti, or a mixture thereof, or when y is 4, M′ is Sn, Ti or Zr or a mixture thereof.

7. The process of any one of claims 4, 5 and 6, wherein M′ is Al.

8. The process of any one of claims 4 to 7, wherein the layered double hydroxide of formula (I) is a Zn/Al, Mg/Al, ZnMg/Al, Ca/Al, Ni/Al or Cu/Al layered double hydroxide.

9. The process of any preceding claim, wherein X is selected from carbonate, bicarbonate, hydrogenphosphate, dihydrogenphosphate, nitrite, borate, nitrate, phosphate and sulphate.

10. The process of any preceding claim, wherein X is carbonate.

11. The process of any preceding claim, wherein the layered double hydroxide is a MgAl—CO₃ layered double hydroxide.

12. The process of any preceding claim, wherein the layered double hydroxide has a platelet morphology, wherein the largest dimension of the platelet is 0.01-10 μm.

13. The process of claim 12, wherein the largest dimension of the platelet is 0.01-1 μm.

14. The process of any one of claims 1 to 11, wherein the layered double hydroxide has a platelet morphology, wherein the average particle size of the platelet is 2.5-10 μm.

15. The process of claim 14, wherein the layered double hydroxide has a platelet morphology, wherein the average particle size of the platelet is 3.5-9 μm.

16. The process of any preceding claim, wherein the aqueous mixture comprises 1-15 wt % of layered double hydroxide.

17. The process of any preceding claim, wherein the aqueous mixture comprises 1-10 wt % of layered double hydroxide.

18. The process of any preceding claim, wherein the aspect ratio of the layered double hydroxide is at least 10, wherein aspect ratio is the average diameter of the layered double hydroxide platelet divided by the average thickness of the layered double hydroxide platelet.

19. The process of any preceding claim, wherein the aqueous mixture comprises 1-20 wt % of water soluble polymer.

20. The process of any preceding claim, wherein the aqueous mixture comprises 1-10 wt % of water soluble polymer.

21. The process of any preceding claim, wherein the aqueous mixture has a total solids content of 5-15 wt %, wherein the weight ratio of water-soluble polymer (e.g. PVA) to LDH within the aqueous mixture is 0.5:1 to 5:1.

22. The process of any preceding claim, wherein the aqueous mixture has a total solids content of 8-12 wt %, wherein the weight ratio of water-soluble polymer (e.g. PVA) to LDH within the aqueous mixture is 0.5:1 to 5:1.

23. The process of any preceding claim, wherein the aqueous mixture has a total solids content of 8-12 wt %, wherein the weight ratio of water-soluble polymer (e.g. PVA) to LDH within the aqueous mixture is 0.75:1 to 4.5:1.

24. The process of any preceding claim, wherein the aqueous mixture has a viscosity of 1-5000 cP.

25. The process of any preceding claim, wherein after step c) and prior to step d), the coated first substrate is contacted with a second substrate, such that the layer of aqueous mixture is provided between the first and second substrates.

26. The process of any one of claims 1 to 24, further comprising the steps of:
e) of applying a layer of adhesive to the dried coated first substrate resulting from step d), such that the layer of adhesive is provided on top of the layer applied during step c); and
f) contacting the layer of adhesive applied in step e) with a second substrate.

27. The process of claim 25 or 26, wherein the second substrate is selected from polyethylene terephthalate (PET), polyethylene (PE), polypropylene (PP), polyamide, nylon, polylactic acid (PLA) and polyvinyl dichloride (PVDC).

28. The process of claim 26 or 27, wherein the adhesive is selected from cellulose acetate, poly(vinyl alchohol) (PVOH), polyvinyl acetate, polyvinyl dichloride (PVDC), polyurethane, an acrylic-based adhesive, an epoxy resin, and mixtures thereof.

29. A film obtainable by the process of any preceding claim.

30. A film comprising:
a) a substrate; and
b) a coating layer provided on a least one surface of the substrate, wherein the coating layer comprises 5-70 wt % of layered double hydroxide dispersed throughout a water-soluble polymeric matrix.

31. The film of claim 30, wherein the layered double hydroxide is randomly dispersed throughout the water-soluble polymeric matrix.

32. The film of claim 30 or 31, wherein the coating layer comprises 10-60 wt % of layered double hydroxide.

33. The film of any one of claim 30, 31 or 32, wherein the weight ratio of water-soluble polymeric matrix (e.g. PVA) to LDH within the coating layer is 0.5:1 to 5:1.

34. The film of claim 33, wherein the weight ratio of water-soluble polymeric matrix (e.g. PVA) to LDH within the coating layer is 0.75:1 to 4.5:1.

35. The film of any one of claims 30 to 34, wherein the layered double hydroxide is as defined in any of claims 4 to 18.

36. The film of any one of claims 30 to 35, wherein the water-soluble polymeric matrix comprises a water-soluble polymer as defined in claim 3.

37. The film of any one of claims 30 to 36, wherein the substrate is as defined in claim 2.

38. The film of any one of claims 30 to 37, wherein the coating layer comprises:
a) 10-60 wt % of layered double hydroxide;
b) 40-90 wt % of water-soluble polymeric matrix; and
c) 0-2 wt % of water.

39. The film of any one of claims 30 to 38, wherein the coating layer has a thickness of 0.1-10 μm (e.g. 1-10 μm).

40. The film of any one of claims 30 to 39, wherein the substrate is a first substrate, and the film comprises a second substrate disposed on top of the coating layer, such that the coating layer is located between the first and second substrates.

41. The film of claim 40, wherein the film comprises a layer of adhesive provided between the coating layer and the second substrate.

42. The film of claim 41, wherein the adhesive is as defined in claim 28.

43. Use of a film as claimed in any one of claims 30 to 42 in packaging.

44. The use of claim 43, wherein the packaging is food packaging.
